(19) United States
(12) Patent Application Publication
(10) Pub. No.: US 2006/0113455 A1
(43) Pub. Date: Jun. 1, 2006

(54) Apparatus for holding umbrella to golf bag

(75) Inventor: Tien-Tsung Chan, Taichung (TW)

Correspondence Address: NIKOLAI & MERSEREAU, P.A., 900 SECOND AVENUE SOUTH, SUITE 820, MINNEAPOLIS, MN, 55402, US

(73) Assignee: Chenterlon Inc., Taichung (TW)

(21) Appl. No.: 10/999,300

(22) Filed: Nov. 29, 2004

(51) Int. Cl. A47G 33/12; H01Q 1/12

(52) U.S. Cl. 248/534

(57) ABSTRACT

An apparatus is provided for holding an umbrella to a golf bag. The umbrella-holding apparatus includes two shackles and at least one elastic element. The shackles can hold the umbrella to the golf bag. The elastic element is connected with the shackles in order to cause the shackles to hold on tight to the umbrella.

### BACKGROUND OF INVENTION

1. Field of Invention

The present invention relates to a golf bag and, more particularly, to an apparatus for holding an umbrella to a golf bag.

2. Related Prior Art

Referring to FIG. 9, a conventional umbrella-holding apparatus is installed on a bag 1. The conventional umbrella-holding apparatus includes a restraint 2 installed on the bag 1 in order to hold. A loop 8 is attached to the bag 1. A tie 3 is inserted through the loop 8. A locking element 4 is installed on the tie 3. An umbrella 9 includes a pole 6 and a handle 7 attached to the pole 6. In addition, the umbrella 9 is equipped with a telescopic protective element 5. The restraint 2 is used to hold the tip of the pole 6 or the telescopic protective element 5. The tie 3 and the locking element 4 are used to hold the handle 7. It is troublesome to operate the tie 3 and the locking element 4 in order to tie the umbrella 9 to the bag 1. It is also troublesome to operate the tie 3 and the locking element 4 in order to untie the umbrella 9 from the bag 1. Moreover, the locking element 4 can easily be worn or damaged so that it cannot be used together with the tie 3.

The present invention is therefore intended to obviate or at least alleviate the problems encountered in prior art.

### SUMMARY OF INVENTION

According to the present invention, an apparatus is provided for holding an umbrella to a golf bag. The umbrella-holding apparatus includes two shackles and at least one elastic element. The shackles can hold the umbrella to the golf bag. The elastic element is connected with the shackles in order to cause the shackles to hold on tight to the umbrella.

The primary advantage of the umbrella-holding apparatus according to the present invention is that the elastic element automatically causes to the shackles to hold on tight to the umbrella.

Other objects, advantages, and novel features of the invention will become more apparent from the following detailed description when taken in conjunction with the drawings.

### BRIEF DESCRIPTION OF DRAWINGS

The present invention will be described through detailed illustration of embodiments referring to the drawings.

FIG. 1 is a perspective view of an umbrella-holding apparatus according to a first embodiment of the present invention.

FIG. 2 is an enlarged perspective partial view of the umbrella-holding apparatus shown in FIG. 1.

FIG. 3 is similar to FIG. 1 but shows an umbrella held by means of the umbrella-holding apparatus.

FIG. 4 is a perspective view of an umbrella-holding apparatus according to a second embodiment of the present.

FIG. 5 is a perspective view of an umbrella-holding apparatus according to a third embodiment of the present.

FIG. 6 is a perspective view of an umbrella-holding apparatus according to a fourth embodiment of the present.

FIG. 7 is a perspective view of an umbrella-holding apparatus according to a fifth embodiment of the present.

FIG. 8 is similar to FIG. 7 but shows the umbrella held by means of the umbrella-holding apparatus.

FIG. 9 is a perspective view of a conventional umbrella-holding apparatus.

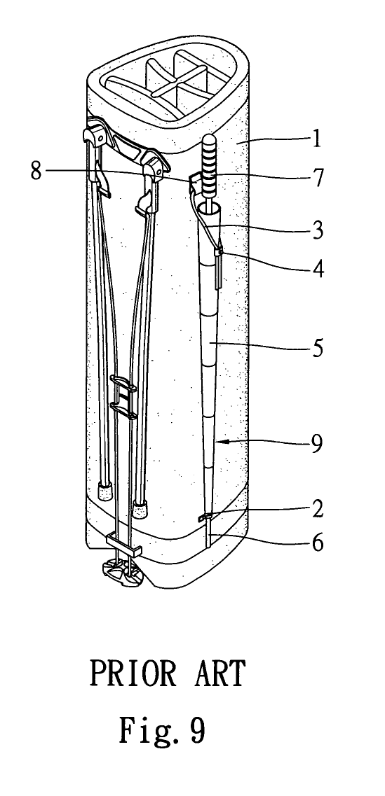

### Detailed Description of Embodiments

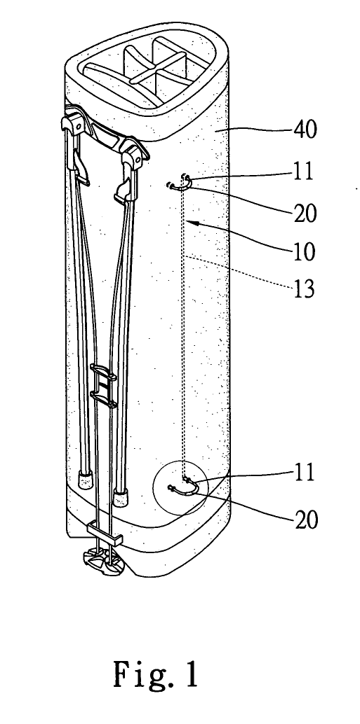

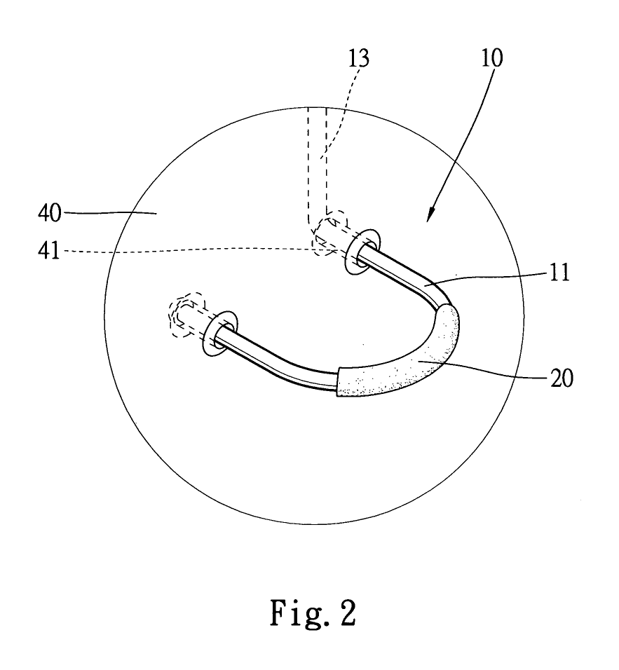

Referring to FIGS. 1 and 2, according to a first embodiment of the present invention, an umbrella-holding apparatus 10 includes two shackles 11 and an elastic element 13 connected with the shackles 11.

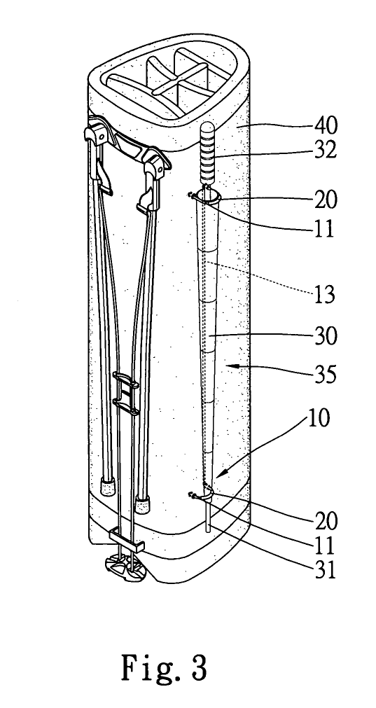

The elastic element 13 is installed in a golf bag 40. Each of the shackles 11 includes a first end attached to the golf bag 40 and a second end connected with the elastic element 13 through an aperture 41 defined in the golf bag 40. A protective element 20 is attached to each of the shackles 11. The protective element 20 is used to protect an umbrella 35 (see FIG. 3). The protective element 20 is made of a soft material. The protective element 20 is in the form of a tube.

FIG. 3 shows the umbrella 35 held by means of the umbrella-holding apparatus 10. The umbrella 35 includes a pole 31, a handle 32 attached to the pole 31 and a telescopic protective element 30 connected with the pole 31 in order to protect the umbrella 35. The telescopic protective element 30 is restrained by means of the shackles 11. Because of the umbrella 35, the shackles 11 are moved from the golf bag 40. Thus, the elastic element 13 is loaded in order to cause the shackles 11 to “hold on tight to” the umbrella 35.

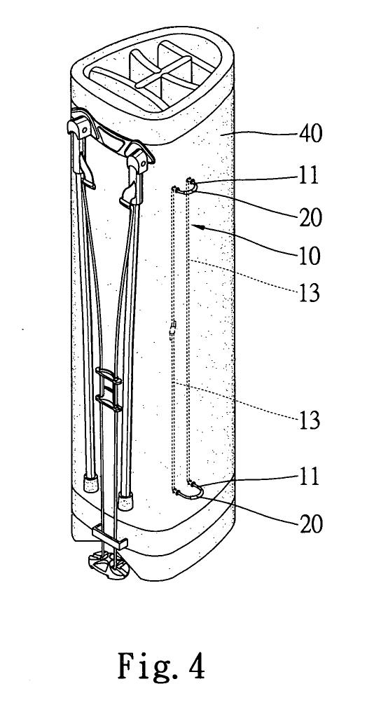

FIG. 4 shows an umbrella-holding apparatus 10 according to a second embodiment of the present invention. The second embodiment is identical to the first embodiment except that the first end of each shackle 11 extends and is connected with the first end of the other shackle 11, thus forming an elastic element in addition to the sole elastic element 13 in the first embodiment.

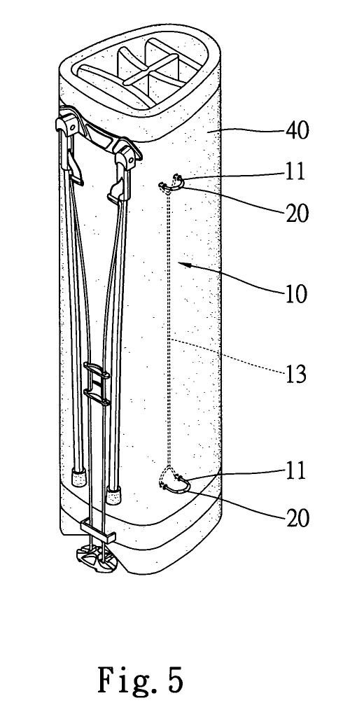

FIG. 5 shows an umbrella-holding apparatus 10 according to a third embodiment of the present invention. The third embodiment is identical to the first embodiment except that both ends of each shackle 11 are connected with the elastic element 13.

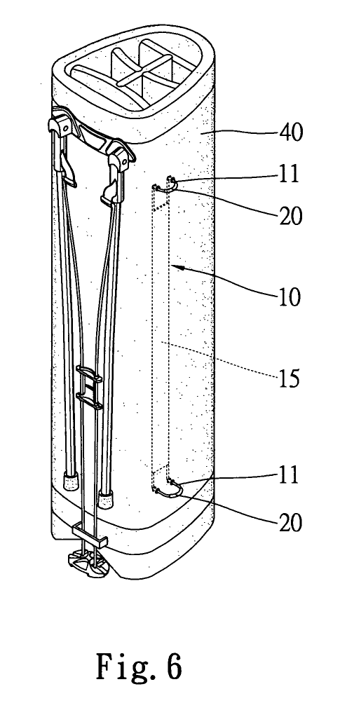

FIG. 6 shows an umbrella-holding apparatus 10 according to a fourth embodiment of the present invention. The fourth embodiment is identical to the first embodiment except that both ends of each shackle 11 are connected with a strap 15 instead of the elastic element 13.

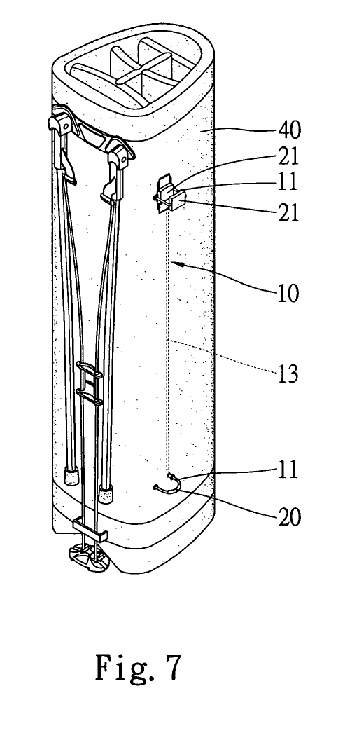

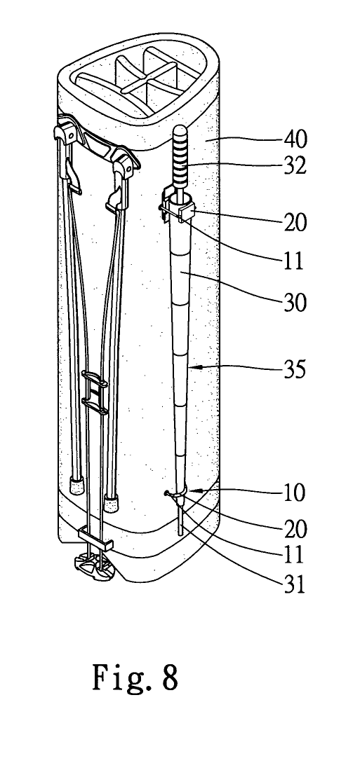

FIGS. 7 and 8 show an umbrella-holding apparatus 10 according to a fifth embodiment of the present invention. The fifth embodiment is identical to the first embodiment except that two protective elements 21 are attached to one of the shackles 11. Each of the protective elements 21 is in the form of a plate.

The present invention has been described through detailed illustration of the embodiments. Those skilled in the art can derive variations from the embodiments. The embodiments hence shall not limit the scope of the present invention defined in the claims.

What is claimed is:

1. An umbrella-holding apparatus for a golf bag, the umbrella-holding apparatus comprising two shackles for holding an umbrella to the golf bag and at least one elastic element connected with the shackles.

2. The umbrella-holding apparatus according to claim 1 wherein each of the shackles comprises a first end secured to the golf bag and a second end connected with the elastic element.

3. The umbrella-holding apparatus according to claim 2 wherein the elastic element is installed in the golf bag, wherein the second end of each of the shackles is inserted through an aperture defined in the golf bag.

4. The umbrella-holding apparatus according to claim 1 wherein each of the shackles comprises two ends connected with the elastic element.

5. The umbrella-holding apparatus according to claim 4 wherein the elastic element is in the form of a rod.

6. The umbrella-holding apparatus according to claim 4 wherein the elastic element is in the form of a strap.

7. The umbrella-holding apparatus according to claim 4 wherein the elastic element is installed in the golf bag, wherein each of the ends of each of the shackles is inserted through an aperture defined in the golf bag.

8. The umbrella-holding apparatus according to claim 1 comprising two elastic elements connected with both of the shackles.

9. The umbrella-holding apparatus according to claim 8 wherein each of the shackles comprises two ends each connected with one of the elastic elements.

10. The umbrella-holding apparatus according to claim 9 wherein the elastic elements are installed in the golf bag, wherein each of the ends of each of the shackles is inserted through an aperture defined in the golf bag.

11. The umbrella-holding apparatus according to claim 1 comprising a protective element attached to each of the shackles in order to protect the umbrella.

12. The umbrella-holding apparatus according to claim 11 wherein each of the protective elements is made of soft material.

13. The umbrella-holding apparatus according to claim 11 wherein each of the protective elements is in the form of a tube.

14. The umbrella-holding apparatus according to claim 11 wherein each of the protective elements is in the form of a plate.
